(19) United States
(12) Patent Application Publication
(10) Pub. No.: US 2018/0266436 A1
(43) Pub. Date: Sep. 20, 2018

(54) ROTARY MACHINE SINGLE-SUCTION INTAKE DEVICE

(71) Applicants: MITSUBISHI HEAVY INDUSTRIES, LTD., Tokyo (JP); MITSUBISHI HEAVY INDUSTRIES COMPRESSOR CORPORATION, Tokyo (JP)

(72) Inventors: Ryosuke SAITO, Tokyo (JP); Xuelin GAO, Tokyo (JP); Ryosuke MITO, Tokyo (JP); Satoru YOSHIDA, Hiroshima-shi (JP)

(73) Assignees: MITSUBISHI HEAVY INDUSTRIES, LTD., Tokyo (JP); MITSUBISHI HEAVY INDUSTRIES COMPRESSOR CORPORATION, Tokyo (JP)

(21) Appl. No.: 15/534,651

(22) PCT Filed: Jun. 10, 2015
(86) PCT No.: PCT/JP2015/066658

§ 371 Date: Jun. 9, 2017

(30) Foreign Application Priority Data
Dec. 11, 2014 (JP) 2014-250614

(51) Int. Cl. F04D 29/42; F02C 7/04

(52) U.S. Cl. CPC F04D 29/4213; F05D 2240/14; F05D 2220/32; F02C 7/04

(57) ABSTRACT

The present invention provides a rotary machine intake casing which, by using a simple configuration, makes it possible to reduce asymmetry between the flow speed of air flowing in a forward direction relative to the direction of rotation of a rotating shaft of a compressor and the flow speed of air flowing in the opposite direction. Thus, a rotary machine single-suction intake device equipped with an upstream duct (121) having a suction port (121a) opening in a direction that intersects the rotational axis of the compressor, and an intake duct body section (102) for guiding air to the compressor after the air has passed into the upstream duct (121), and connected to the upstream duct (121), wherein the channel cross-sectional area on the forward direction side (A) relative to the rotational direction of the rotating shaft differs from the channel cross-sectional area on the opposite direction side (B) relative thereto, according to the flow distortion trend of the air passing through the interior of the intake duct body section (102), so as to equalize the flow speed distribution of air passing through the forward direction side (A) relative to the rotational direction of the rotating shaft and the flow speed distribution of air passing through the opposite direction side (B) relative thereto.

### TECHNICAL FIELD

The present invention relates to a rotary machine single-suction intake device.

### BACKGROUND ART

In the related art, in most cases, a centrifugal compressor adopts a single-suction intake device. In addition, an axial compressor such as a gas turbine also adopts the single-suction intake device.

FIG. 10 schematically shows an example of an intake duct of a gas turbine as a rotary machine single-suction intake device in the related art. As shown in FIG. 10, the intake duct of the related art includes an upstream duct (upstream side casing) 101 into which air (fluid) flows from the outside, and an intake duct body section (downstream side casing) 102 which is connected to an outlet portion 101b of the upstream duct 101 and through which air passing through the inside of the upstream duct 101 is introduced to a compressor (not shown).

The air which flows from the suction port 101a is introduced through the upstream duct 101 in a direction approximately orthogonal to a rotational axis RL, and the shape of the suction port 101a and the shape of the outlet portion 101b are approximately the same as each other (widths W and depths D on the suction port 101a side and the outlet portion 101b side are approximately constant).

In addition, the intake duct body section 102 is provided so as to surround a rotating shaft (not shown) on an outside in a radial direction of the rotating shaft, and includes a tubular channel 102a (hereinafter, referred to as a compressor-side channel) which is formed along an outer periphery of the rotating shaft on the compressor side.

Here, in the rotary machine single-suction intake device such as the centrifugal compressor or the axial compressor in the related art, when air is suctioned, although there is a difference in degree, there is always a difference between a flow speed on a forward direction side (a range indicated by A in FIG. 10 in the example shown in FIG. 10) relative to a rotational direction of the rotating shaft and a flow speed on an opposite direction side (a range indicated by B in FIG. 10 in the example shown in FIG. 10) relative thereto.

For example, in the case of the centrifugal compressor, as shown in FIG. 12, a flow rate on the forward direction side (between −180° and 0°) relative to the rotational direction of the rotating shaft is small, and a flow rate on the opposite direction side (between 0° and 180°) relative thereto is large.

In addition, in the case of the axial compressor, as shown in FIG. 11, a flow rate on the forward direction side (between W₀ to W_{A}) relative to the rotational direction of the rotating shaft is large, and a flow rate on the opposite direction side (between W₀ to W_{B}) relative thereto is small.

That is, since flows of air in the inlet of the compressor are asymmetrical due to effects of rotation of a rotor blade or an IGV inlet angle, as shown in FIGS. 11 and 12, air easily flows into any one of the forward direction side and the opposite direction side relative to the rotational direction of the rotating shaft, and a flow distortion occurs.

Since the flow distortion generates a peripheral direction distribution in the inlet of the rotary machine, there is a problem that variation in performance of the rotary machine occurs in the peripheral direction of the rotating shaft.

With respect to the problem, in PTL 1 below, a restriction member which covers an air intake port and partially blocks an air flow around the air intake port is provided to obtain a uniform air flow distribution over the entire air intake port. Moreover, PTL 2 below discloses a fluid machine in which a fitting part is attached to a cavity portion of a suction casing to uniformly introduce a fluid in a peripheral direction.

### CITATION LIST

### Patent Literature

[PTL 1] Japanese Unexamined Patent Application Publication No. 2010-203251
[PTL 2] Japanese Unexamined Patent Application Publication No. 2013-194513

### SUMMARY OF INVENTION

### Technical Problem

However, in the inventions disclosed in PTLs 1 and 2, there is a problem that separate members are required to be added.

From the above-described problem, an object of the present invention is to provide a rotary machine single-suction intake device in which asymmetry between the flow speed of a fluid flowing in a forward direction relative to a rotational direction of a rotating shaft of a compressor and a flow speed of a fluid flowing in an opposite direction relative thereto can be reduced using a simpler configuration.

### Solution to Problem

In order to achieve the object, according to a first invention, there is provided a rotary machine single-suction intake device which includes an upstream side casing having a suction port opening in a direction which intersects a rotational axis of a rotary machine and a downstream side casing which is connected to the upstream side casing and through which a fluid passing through the inside of the upstream side casing is introduced to the rotary machine, in which a channel cross-sectional area on a forward direction side relative to a rotational direction of a rotating shaft is different from a channel cross-sectional area on an opposite direction side relative thereto so as to equalize a flow speed distribution of a fluid passing through the forward direction side relative to the rotational direction of the rotating shaft and a flow speed distribution of a fluid passing through the opposite direction side, according to a flow distortion trend of the fluid passing through the inside of the downstream side casing.

In addition, in the rotary machine single-suction intake device according to a second invention, in the rotary machine single-suction intake device according to the first invention, widths of the suction port on the forward direction side and the opposite direction side relative to the rotational direction of the rotating shaft are different from each other.

Moreover, in the rotary machine single-suction intake device according to a third invention, in the rotary machine single-suction intake device according to the first invention, the downstream side casing includes a tubular channel which is formed on the rotary machine side, and channel cross-sectional areas of an inlet-side opening portion of the channel on the forward direction side and the opposite direction side relative to the rotational direction of the rotating shaft are different from each other.

In addition, in the rotary machine single-suction intake device according to a fourth invention, in the rotary machine single-suction intake device according to the first invention, depths of the suction port on the forward direction side and the opposite direction side relative to the rotational direction of the rotating shaft are different from each other.

### Advantageous Effects of Invention

According to the rotary machine single-suction intake device of the present invention, it is possible to reduce asymmetry between the flow speed of the fluid flowing in the forward direction relative to the rotational direction of the rotating shaft of the compressor and the flow speed of the fluid flowing in the opposite direction relative thereto using a simple configuration.

### BRIEF DESCRIPTION OF DRAWINGS

FIG. 1 is an overall view in which a gas turbine to which a rotary machine single-suction intake device according to the present invention is applied is partially cut out.

FIG. 2 is a perspective view schematically showing a rotary machine single-suction intake device according to Example 1 of the present invention.

FIG. 3 is a front view schematically showing a shape of a suction port of the rotary machine single-suction intake device according to Example 1 of the present invention.

FIGS. 4A and 4B are graphs showing a flow speed distribution in the rotary machine single-suction intake device according to Example 1 of the present invention, FIG. 4A shows a flow speed distribution in a suction port of an upstream duct, and FIG. 4B shows a flow speed distribution in an outlet portion of the upstream duct.

FIGS. 5A to 5C are views schematically showing a rotary machine single-suction intake device according to Example 2 of the present invention, FIG. 5A is a perspective view, FIG. 5B is a front view, and FIG. 5C is a sectional view of a compressor-side channel.

FIGS. 6A and 6B are view schematically showing a rotary machine single-suction intake device according to Example 3 of the present invention, FIG. 6A is a perspective view and FIG. 6B is a front view.

FIGS. 7A and 7B are view schematically showing another example of the rotary machine single-suction intake device according to Example 3 of the present invention, FIG. 7A is a perspective view and FIG. 7B is a front view.

FIGS. 8A to 8C are graphs showing a flow speed distribution in the rotary machine single-suction intake device shown in FIGS. 6A and 6B, FIG. 8A shows a flow speed distribution in a suction port of an upstream duct, FIG. 8B shows a flow speed distribution in a bent portion on a forward direction-side wall surface, and FIG. 8C shows a flow speed distribution in an outlet portion of the upstream duct.

FIGS. 9A to 9C are graphs showing a flow speed distribution in the rotary machine single-suction intake device shown in FIGS. 7A and 7B, FIG. 9A shows a flow speed distribution in a suction port of an upstream duct, FIG. 9B shows a flow speed distribution in a bent portion on an opposite direction-side wall surface, and FIG. 9C shows a flow speed distribution in an outlet portion of the upstream duct.

FIG. 10 is a perspective view schematically showing a rotary machine single-suction intake device of the related art.

FIG. 11 is a graph showing a flow speed distribution in an intake device which is applied to an axial compressor in the related art.

FIG. 12 is a graph showing a flow speed distribution in an intake device which is applied to a centrifugal compressor in the related art.

### DESCRIPTION OF EMBODIMENTS

Hereinafter, an embodiment of a rotary machine single-suction intake device according to the present invention will be described.

The rotary machine single-suction intake device according to the present embodiment is a rotary machine single-suction intake device which includes an upstream side casing having a suction port opening in a direction which intersects a rotational axis of a rotary machine and a downstream side casing which is connected to the upstream side casing and through which a fluid passing through the inside of the upstream side casing is introduced to the rotary machine, and distributions in intake flow rates are biased to a forward direction side and an opposite direction side relative to a rotational direction of a rotating shaft by a single-suction intake device positioned on the upstream side of the rotary machine. Accordingly, effects of flow distortions generated by the rotation of the rotating shaft are cancelled off, and it is possible to obtain a uniform flow speed distribution in a peripheral direction in an inlet portion of the rotary machine.

A ratio of the intake flow rates between the forward direction side and the opposite direction side can be realized by changing a channel cross-sectional area of the single-suction intake device on the forward direction side and the opposite direction side relative to the rotational direction of the rotating shaft.

Here, (density)×(speed)×(cross-sectional area)=constant is satisfied according to a flow conservation law, and since a speed is low in a case of a suction casing, the density ρ is approximately constant, and there is an inverse proportional relationship between the speed and the cross-sectional area.

For example, in an example of a flow speed distribution in a single-suction intake device which is applied to an axial compressor of the related art shown in FIG. 11, if it is considered that a channel is divided into channels on a forward direction side and on an opposite direction side relative to the rotational direction of the rotating shaft in flows of an inlet portion of a downstream side casing, a flow rate of the channel on the forward direction side is large (flow speed=approximately 104% of average flow speed), and the flow rate of the channel on the opposite direction side is small (flow speed=approximately 96% of average flow speed).

In order to average the flow rates, if the ratio between the channel cross-sectional area on the forward direction side and the channel cross-sectional area on the opposite direction side is set to 96:104 so as to be an inverse number of the flow speed ratio, the flow distortion is alleviated, and a vertically symmetrical flow is achieved.

Hereinafter, a specific example of the rotary machine single-suction intake device according to the present invention will be described in detail according to Examples. In addition, the present invention is not limited to the following Examples, and various modifications may be applied within a scope which does not depart from the gist of the present invention.

### Example 1

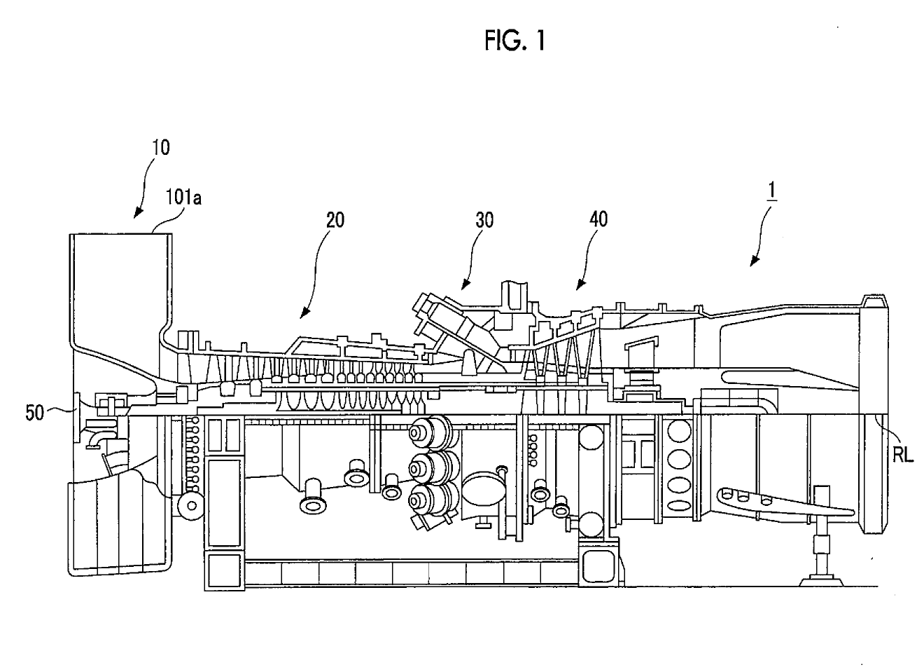

A rotary machine single-suction intake device according to Example 1 of the present invention will be described with reference to FIGS. 1 to 4B.

As shown in FIG. 1, the rotary machine single-suction intake device according to the present Example is a single-suction intake duct 10 which is disposed on an upstream side of a gas turbine 1 and suctions air (fluid) in a direction approximately orthogonal to a rotational axis RL. In addition, a reference numeral 20 in FIG. 1 indicates a compressor (axial compressor), a reference numeral 30 indicates a combustor, a reference numeral 40 indicates a turbine, and a reference numeral 50 indicates a rotating shaft.

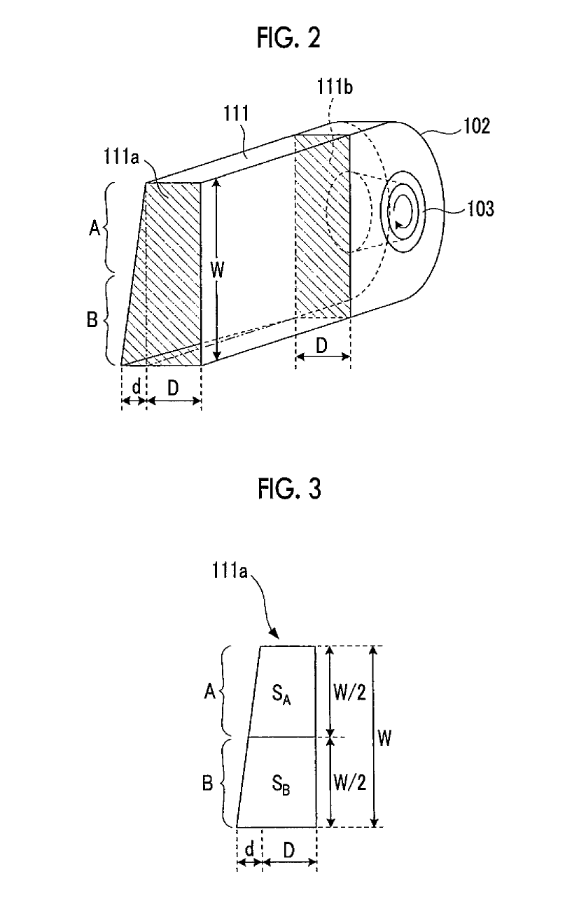

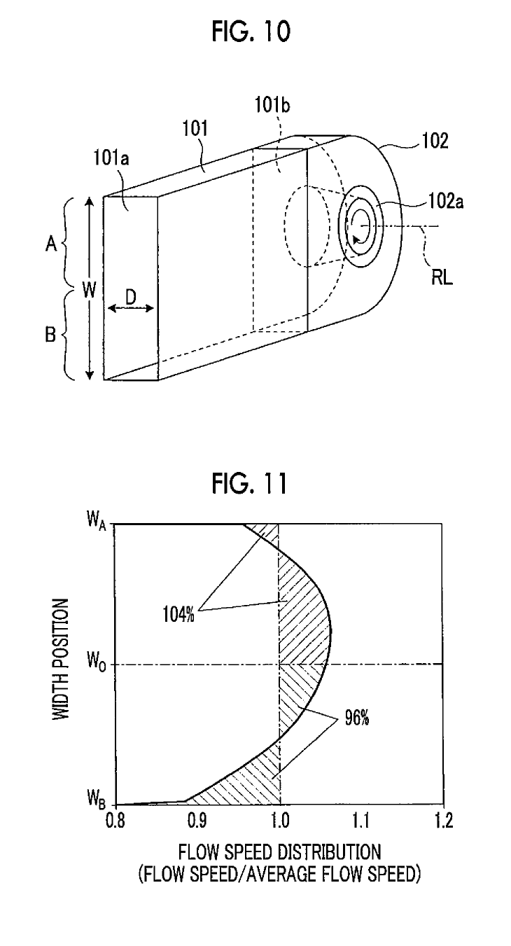

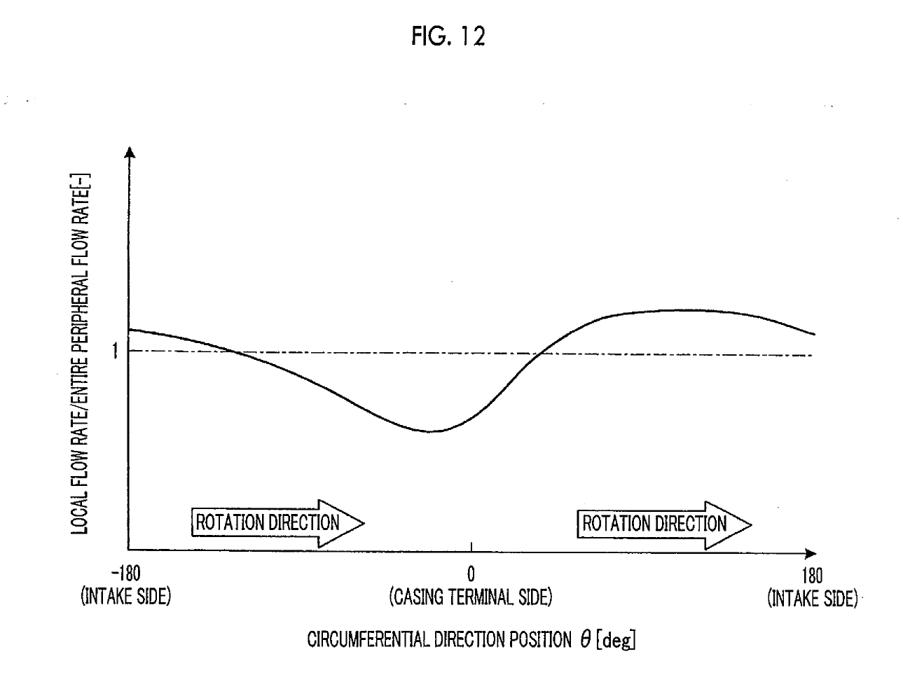

The rotary machine single-suction intake device according to the present Example adopts an upstream duct (upstream side casing) 111 shown in FIG. 2 instead of the above-described upstream duct 101 in the related art shown in FIG. 10. Other configurations are approximately similar to the configurations of the related art, and hereinafter, the configurations different from those of the intake duct shown in FIG. 10 are mainly described, and overlapping descriptions are omitted.

As shown in FIG. 2, in the upstream duct 111 of the present Example, a shape of a suction port 111a is different from that of the upstream duct 101 of the related art. Specifically, while a depth of an outlet portion 111b of the upstream duct 111 in a width direction (a direction orthogonal to the rotational axis RL and an inflow direction of air) has a constant length D, the depth of the suction port 111a is changed in the width direction.

More specifically, while a depth at an end portion on a forward direction side (a side which is positioned further forward than the center in the width direction W) A relative to the rotational direction of the rotating shaft 50 is the length D, a depth at an end portion on an opposite direction side (in the present Example, a side which is positioned further backward than the center in the width direction W) B relative to the rotational direction of the rotating shaft is a length D+d (d>0) and is longer than the depth at the end portion on the forward direction side A. In short, in the present Example, the suction port 111a has a trapezoidal shape in which the end portion on the forward direction side A is a short side and the end portion on the opposite direction side B is a long side, and the channel cross-sectional areas on the forward direction side A and the opposite direction side B are different from each other.

Here, as shown in FIG. 3, a size relation of areas (channel cross-sectional areas) of two trapezoids which are obtained by dividing the shape of the suction port 111a by the center in the width direction is set according to the flow speed distributions of the intake duct of the related art. That is, S_{A}:S_{B}=b:a is satisfied such that a ratio S_{A}:S_{B} between an area S_{A} of the trapezoid on the forward direction side A and an area S_{B} of the trapezoid on the opposite direction side B becomes an inverse number of the ratio a:b between the flow speed distribution on the forward direction side and the flow speed distribution on the opposite direction side shown in FIG. 11.

For example, if the ratio between the flow speed distribution on the forward direction side and the flow speed distribution on the opposite direction side shown in FIG. 11 is 104:96, a length d is set such that the ratio between the area S_{A} of the trapezoid on the forward direction side A and the area S_{B} of the trapezoid on the opposite direction side B becomes 96:104.

That is, the length d is represented by the following Expression (1) from S_{A}:S_{B}=(2D+3d/2)×W/4:(2D+d/2)×W/4=96:104.

d≈0.17D (1)

In order to set the ratio S_{A}:S_{B} between the area S_{A} of the trapezoid of the forward direction side A and the area S_{B} of the trapezoid on the opposite direction side B to 96:104, the length d may be approximately 17% of the depth D of the end portion on the forward direction side A.

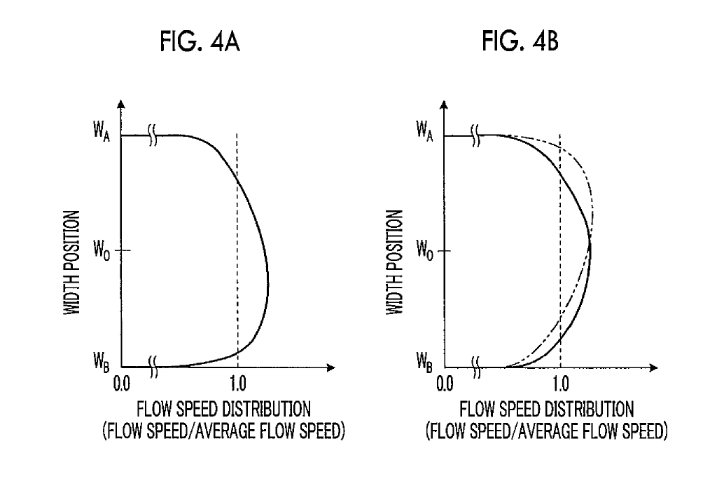

According to the intake duct of the rotary machine according to the above-described present Example, since the shape of the suction port 111a is set such that the channel cross-sectional area S_{B} on the opposite direction side B is larger than the channel cross-sectional area S_{A} of the forward direction side A, an inflow speed of air on the opposite direction side B in the suction port 111a of the upstream duct 111 can be accelerated as shown in FIG. 4A, and with respect to the flow speed distribution of the related art shown by a two-dot chain line shown in FIG. 4B, the distribution on the inlet flow speed of the compressor 30 on the forward direction side A and the distribution on the inlet flow speed of the compressor 30 on the opposite direction side B are uniformized, and it is possible to reduce asymmetry between the flow speed of the air flowing through the forward direction side A and the flow speed of the air flowing through the opposite direction side B by a simple configuration.

Moreover, in the present Example, as shown in FIGS. 2 and 3, the example is shown in which the depth of the suction port 101a of the end portion on the opposite direction side B with respect to the end portion on the forward direction side A is enlarged toward the left side. However, the present invention is not limited to the above-described Example, the depth of the end portion on the opposite direction side B with respect to the end portion on the forward direction side A may be enlarged toward the right side or the depth of the end portion on the opposite direction side B may be enlarged toward both sides of the right and left sides as long as the channel cross-sectional area S_{B} on the opposite direction side B is larger than the channel cross-sectional area S_{A} on the forward direction side A, the inflow speed of the air on the opposite direction side B is accelerated, and asymmetry in the related art can be reduced.

Moreover, in the shape of the suction port 101a of the upstream duct 101, all surfaces may be flat surfaces as shown in FIGS. 2 and 3, or some surfaces may be curved surfaces.

In addition, in the present Example, the example is shown in which the length d is set such that the ratio between the area S_{A} of the trapezoid on the forward direction side A and the area S_{B} of the trapezoid on the opposite direction side B satisfies S_{A}:S_{B}=96:104. However, the ratio S_{A} S_{B} between the area S_{A} of the trapezoid on the forward direction side A and the area S_{B} of the trapezoid on the opposite direction side B may be appropriately set according to the flow rate distribution of the rotary machine single-suction intake device which is applied to the present invention.

In addition, in the present Example, the example is shown in which the length d≈0.17D is satisfied. However, the length d may be any length as long as the length d is within a range of 0<d<0.35D

Moreover, in the present Example, the example is shown in which the present invention is applied to the axial compressor of the gas turbine. However, it is needless to say that the present invention can be also applied to a centrifugal compressor. This is similarly applied to the following Examples 2 and 3.

### Example 2

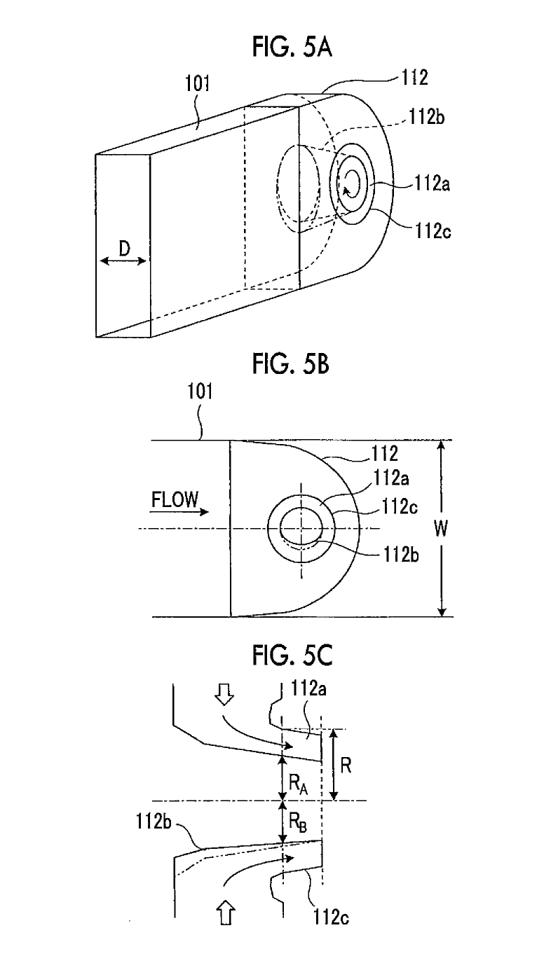

A rotary machine single-suction intake device according to Example 2 of the present invention will be described with reference to FIGS. 5A to 5C.

The rotary machine single-suction intake device according to the present Example adopts an intake duct body section (downstream side casing) 112 shown in FIGS. 5A to 5C instead of the above-described intake duct body section 102 of the related art shown in FIG. 10. Other configurations are approximately similar to the configurations of the related art, and hereinafter, the configurations different from those of the intake duct shown in FIG. 10 are mainly described, and overlapping descriptions are omitted.

As shown in FIGS. 5A to 5C, in the intake duct body section 112 of the present Example, a shape of a compressor-side channel 112a is different from that of the intake duct body section 102 of the related art. Specifically, while an outer diameter side wall surface (hereinafter, referred to as a channel outer diameter-side wall surface) 112c of the compressor-side channel 112a has a shape similar to that of the related art, an inner diameter wall surface (hereinafter, referred to as a channel inner diameter-side wall surface) 112b of the compressor-side channel 112a has a shape different from that of the related art.

More specifically, while the channel inner diameter-side wall surface 112b has a shape (a perfect circular shape having a radius R_{A} in a sectional view) similar to the shape of the related art on the forward direction side A, an upstream side of the compressor-side channel 112a on the opposite direction side B has an elliptical arc shape in a sectional view (an elliptical arc shape in which a long diameter in a sectional view is the length R_{A} which is the same as that of the related art and a short diameter is the length R_{B} (R_{B}<R_{A})), a downstream side (inlet side of the compressor 30) of the compressor-side channel 112a has a perfect circular shape in a sectional view similarity to the related art, and the channel cross-sectional areas on the upstream side of the compressor-side channel 112a on the forward direction side A and the opposite direction side B are different from each other.

Here, a size relation between the channel cross-sectional areas on the forward direction side A and the opposite direction side B of the compressor-side channel 112a on the upstream side of the compressor-side channel 112a is set according to the flow speed distribution of the intake duct of the related art. That is, S_{A}:S_{B}=b:a is satisfied such that the ratio S_{A} S_{B} between the channel cross-sectional area S_{A} on the forward direction side A and the channel cross-sectional area S_{B} on the opposite direction side B becomes an inverse number of the ratio a:b between the flow speed distribution on the forward direction side A and the flow speed distribution on the opposite direction side B shown in FIG. 11.

For example, if the ratio between the flow speed distribution on the forward direction side A and the flow speed distribution on the opposite direction side B shown in FIG. 11 is 104:96, a length R_{B} is set such that the ratio between the channel cross-sectional area S_{A} on the forward direction side A and the channel cross-sectional area S_{B} on the opposite direction side B becomes 96:104.

That is, in a case where R_{A} is 0.70R, the length R_{B} is represented by the following Expression (2) from S_{A}:S_{B}=π(R²−R_{A}²):π(R²−R_{A}R_{B})=96:104.

R_{B}≈0.92R_{A} (2)

Accordingly, in the case where R_{A} is 0.70R, in order to set the ratio S_{A}:S_{B} between the channel cross-sectional area S_{A} on the forward direction side A and the channel cross-sectional area S_{B} on the opposite direction side B to 96:104, the short diameter R_{B} of the channel inner diameter-side wall surface 112b on the opposite direction side B may be approximately 92% of the radius (the long diameter of the channel inner diameter-side wall surface 112b on the opposite direction side B) R_{A} on the forward direction side A.

According to the intake duct of the rotary machine according to the above-described present Example, in the upstream side of the compressor-side channel 112a, since the channel cross-sectional area S_{B} on the opposite direction side B of the compressor-side channel 112a is larger than the channel cross-sectional area S_{A} on the forward direction side A, similarly to the above-described Example 1, the inflow speed of the air on the opposite direction side B can be accelerated, and as shown in FIG. 4B, the flow speed distributions of the air in the inlet of the intake duct body section 112 on the forward direction side A and the opposite direction side B are uniformized, and it is possible to reduce asymmetry between the flow speed of the air flowing through the forward direction side A and the flow speed of the air flowing through the opposite direction side B by a simple configuration.

Moreover, in the present Example, the example is shown in which the diameter of the channel inner diameter-side wall surface 112b on the opposite direction side B is larger than that of the related art. However, the present invention is not limited to the above-described Example, and for example, the diameter of the channel outer diameter-side wall surface 112c on the forward direction side A may be larger than that of the related art, or the diameter of the channel inner diameter-side wall surface 112b on the opposite direction side B may be larger than that of the related art and the diameter of the channel outer diameter-side wall surface 112c on the forward direction side A may be larger than that of the related art.

Moreover, the present Example may be combined with the above-described Example 1.

In addition, in the present Example, the example is shown in which the short diameter R_{B} is set such that the ratio between the channel cross-sectional area S_{A} on the forward direction side A and the channel cross-sectional area S_{B} on the opposite direction side B satisfies S_{A}:S_{B}=96:104. However, the ratio S_{A}:S_{B} between the area S_{A} of the trapezoid on the forward direction side A and the area S_{B} of the trapezoid on the opposite direction side B may be appropriately set according to the flow rate distribution of the rotary machine single-suction intake device which is applied to the present invention.

In addition, in the present Example, the example is shown in which the ratio between the long diameter R_{A} and the short diameter R_{B} of the channel inner diameter-side wall surface 112b on the opposite direction side B satisfies R_{B}/R_{A}≈0.92. However, the ratio between the long diameter R_{A} and the short diameter R_{B} may be any ratio as long as it is within a range of 0.8≤R_{B}/R_{A}<1.

### Example 3

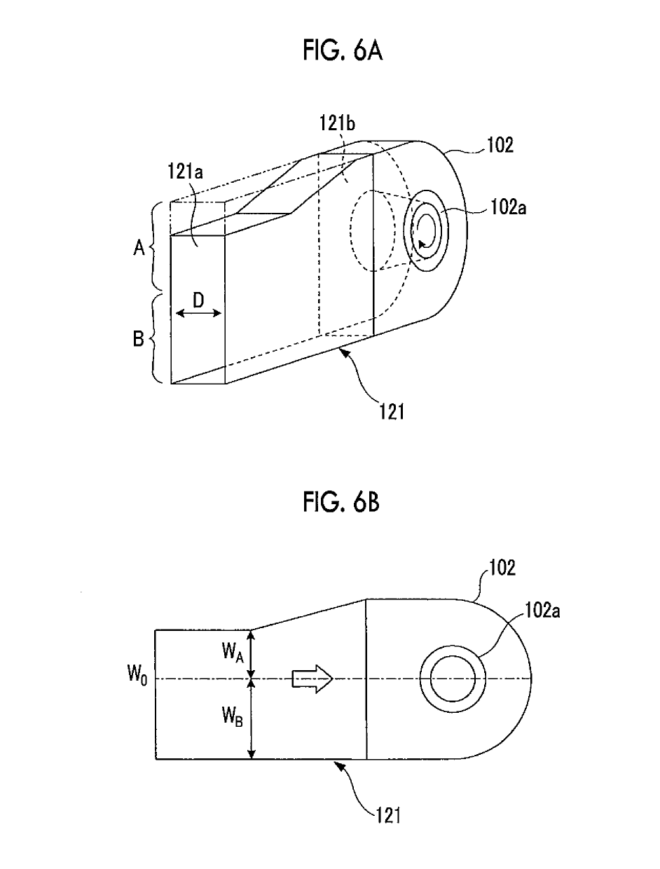

A rotary machine single-suction intake device according to Example 3 of the present invention will be described with reference to FIGS. 6A to 9C.

The rotary machine single-suction intake device according to the present Example adopts an upstream duct (upstream side casing) 121 shown in FIGS. 6A and 6B instead of the above-described upstream duct (upstream side casing) 101 of the related art shown in FIG. 10. Other configurations are approximately similar to the configurations of the related art, and hereinafter, the configurations different from those of the intake duct shown in FIG. 10 are mainly described, and overlapping descriptions are omitted.

As shown in FIGS. 6A and 6B, in the upstream duct 121 of the present Example, a shape of the upstream duct 121 on a suction port 121a side is different from that of the upstream duct 101 of the related art. Specifically, the shape of the upstream duct 121 on the forward direction side A is different from that of the related art, and the shape of the upstream duct 121 on the opposite direction side B is similar to that of the related art.

More specifically, in the suction port 121a side, in the shape on the forward direction side A of the upstream duct 121, a width W_{A} on the side A which is positioned further forward than a center W₀ (hereinafter, referred to as a center W₀ in a width direction) of the outlet portion 121b in the width direction and a width W_{B} on the side B which is positioned further backward than the center W₀ in the width direction are different from each other, and the channel cross-sectional areas on the forward direction side A and the opposite direction side B are different from each other.

Here, in the present Example, the size relation between the width W_{A} of the suction port 121a on the side A which is positioned further forward than the center W₀ in the width direction and the width W_{B} of the suction port 121a on the side B which is positioned further backward than the center W₀ in the width direction is set according to the flow speed distribution of the intake duct of the related art. That is, W_{A}:W_{B}=b:a is satisfied such that the ratio W_{A}:W_{B} between the width W_{A} of the suction port 121a on the forward direction side A and the width W_{B} of the suction port 121a on the opposite direction side B becomes an inverse number of the ratio a:b between the flow speed distribution on the forward direction side A and the flow speed distribution on the opposite direction side B shown in FIG. 11.

For example, if the ratio between the flow speed distribution on the forward direction side A and the flow speed distribution on the opposite direction side B shown in FIG. 11 is 104:96, the width W_{A} is set such that the ratio between the width W_{A} of the suction port 121a on the forward direction side A and the width W_{B} of the suction port 121a on the opposite direction side B becomes 96:104.

That is, the width W_{A} is represented by the following Expression (3).

W_{A}≈0.92W_{B} (3)

Accordingly, the width W_{A} of the suction port 121a on the forward direction side A may be approximately 92% of the width W_{B} of the suction port 121a on the opposite direction side B.

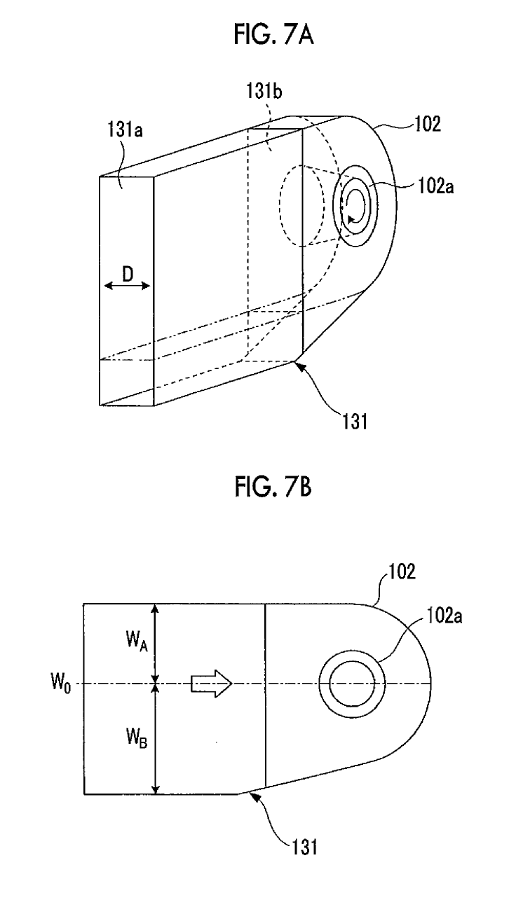

In addition, as shown in FIGS. 7A and 7B, the shape on the forward direction side A of an upstream duct (upstream side casing) 131 may be similar to that of the related art, and the shape on the opposite direction side B of the upstream duct 131 may be different from the shape of the related art shown by a two-dot chain line. More specifically, in a suction port 131a side, the width W_{B} on the side B which is positioned further backward than the center W₀ in the width direction of the upstream duct 131 is longer than that of the related art, and the channel cross-sectional areas on the forward direction side A and the opposite direction side B are different from each other.

Even in this case, the size relation between the width W_{A} of the suction port 131a on the side A which is positioned further forward than the center W₀ in the width direction and the width W_{B} of the suction port 131a on the side B which is positioned further backward than the center W₀ in the width direction is set according to the flow speed distribution of the intake duct of the related art.

For example, if the ratio between the flow speed distribution on the forward direction side A and the flow speed distribution on the opposite direction side B shown in FIG. 11 is 104:96, the width W_{B} is set such that the ratio between the width W_{A} of the suction port 131a on the forward direction side A and the width W_{B} of the suction port 131a on the opposite direction side B becomes W_{A}:W_{B} 96:104.

That is, the width W_{B} is represented by the following Expression (4).

W_{B}≈1.08W_{A} (4)

Accordingly, in the example shown in FIGS. 7A and 7B, the width W_{B} of the suction port 131a on the opposite direction side B may be approximately 108% of the width W_{A} of the suction port 131a on the forward direction side A.

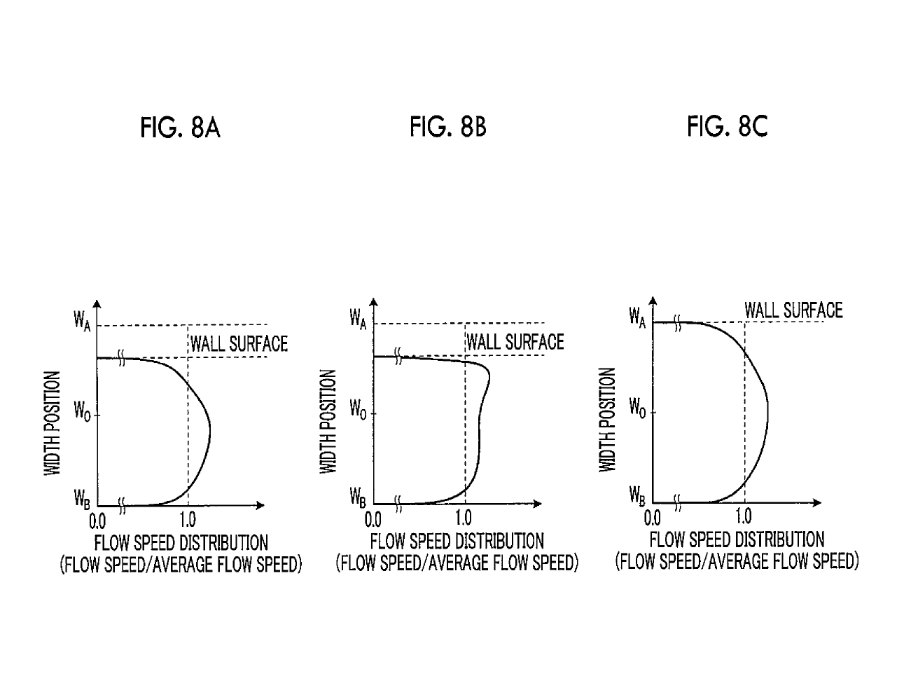

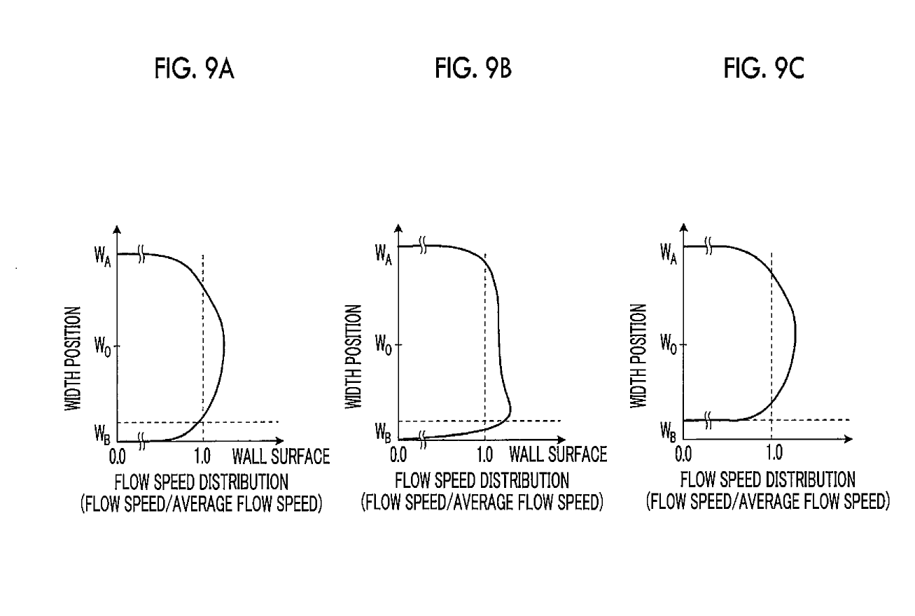

According to the intake duct of the rotary machine according to the above-described present Example, in the suction port 121a or the suction port 131a, the channel cross-sectional area S_{B} on the opposite direction side B is larger than the channel cross-sectional area S_{A} on the forward direction side A and the intake flow rate on the opposite direction side B is greater than the intake flow rate on the forward direction side A. Accordingly, the inflow speed of the air on the opposite direction side B can be accelerated, and as shown in FIGS. 8A and 9A, the inflow speed of the air on the opposite direction side B in the suction port 111a of the upstream duct 111 can be accelerated, the inlet flow speed distributions on the forward direction side A and the opposite direction side B of the intake duct body section 102 can be uniformized as shown in FIGS. 8C and 9C via states shown in FIGS. 8B and 9B, and it is possible to reduce asymmetry between the flow speed of the air flowing through the forward direction side A and the flow speed of the air flowing through the opposite direction side B using a simple configuration.

Moreover, in the present Example, the example is shown in which the widths are set such that the ratio between the width W_{A} of the suction port 121a on the forward direction side A and the width W_{B} of the suction port 121a on the opposite direction side B satisfies W_{A}:W_{B}=96:104. However, the ratio between the width W_{A} of the suction port 121a on the forward direction side A and the width W_{B} of the suction port 121a on the opposite direction side B may be appropriately set according to the flow rate distribution of the rotary machine single-suction intake device to which the present invention is applied.

For example, in the present Example, the example is shown in which the width W_{A}≈0.92W_{B} is satisfied. However, in a case where it is assumed that the maximum difference between the flow speed distribution on the forward direction side and the flow speed distribution on the opposite direction side shown in FIG. 11 is 20%, the W_{A} may be any width as long as it is within a range of 0.66W_{B}≤W_{A}<W_{B}.

### INDUSTRIAL APPLICABILITY

The present invention is appropriately applied to a rotary machine single-suction intake device.

### REFERENCE SIGNS LIST

1: gas turbine
10: intake duct
20: compressor
30: combustor
40: gas turbine
50: rotating shaft
101, 111, 121, 131: upstream duct
101a, 111a, 121a, 131a: suction port
101b, 111b, 121b, 131b: outlet portion
102, 112: intake duct body section
102a, 112a: compressor-side channel
112b: channel inner diameter-side wall surface
112c: channel outer diameter-side wall surface

1. A rotary machine single-suction intake device which includes an upstream side casing having a suction port opening in a direction which intersects a rotational axis of a rotary machine and a downstream side casing which is connected to the upstream side casing and through which air passing through the inside of the upstream side casing is introduced to the rotary machine,
wherein a channel cross-sectional area on a forward direction side relative to a rotational direction of a rotating shaft is different from a channel cross-sectional area on an opposite direction side relative thereto so as to equalize a flow speed distribution of air passing through the forward direction side relative to the rotational direction of the rotating shaft and a flow speed distribution of air passing through the opposite direction side, according to a flow distortion trend of the air passing through the inside of the downstream side casing.

2. The rotary machine single-suction intake device according to claim 1,
wherein widths of the suction port on the forward direction side and the opposite direction side relative to the rotational direction of the rotating shaft are different from each other.

3. The rotary machine single-suction intake device according to claim 1,
wherein the downstream side casing includes a tubular channel which is formed on the rotary machine side, and
wherein channel cross-sectional areas of an inlet-side opening portion of the channel on the forward direction side and the opposite direction side relative to the rotational direction of the rotating shaft are different from each other.

4. The rotary machine single-suction intake device according to claim 1,
wherein depths of the suction port on the forward direction side and the opposite direction side relative to the rotational direction of the rotating shaft are different from each other.
